(19) United States
(12) Patent Application Publication
(10) Pub. No.: US 2010/0043984 A1
(43) Pub. Date: Feb. 25, 2010

(54) Device for the welding of plastic membranes

(75) Inventors: Hansruedi Voney, Starrkirch-Wil (CH); Armin Flück, Kerns (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/308,394

(22) PCT Filed: Aug. 3, 2007
(86) PCT No.: PCT/EP2007/058094

§ 371 Date: May 6, 2009

(30) Foreign Application Priority Data
Aug. 4, 2006 (EP) 06118461.0

(51) Int. Cl. B32B 37/00

(52) U.S. Cl. 156/580; 156/349

(57) ABSTRACT

The invention relates to a device for the heat sealing of plastic membranes that contain a nozzle attachment, with the nozzle attachment having an abrasive member and being held flexibly. Thus, the nozzle attachment is positioned with a defined force on the lower membrane that is to be heat sealed, resulting in a seam of consistently high quality.

### TECHNICAL FIELD

The present invention relates to a device for the welding of films or plastic membranes according to the preamble of claim 1.

### PRIOR ART

Devices for the welding of plastic membranes are used particularly for connecting plastic membranes in order to seal off buildings or civil engineering structures, in particular in earthworks and hydraulic engineering structures, for example in the case of flat roofs, pitched roofs, tent-like roof structures, swimming pools, etc., and, in particular, must conform to the Directives of the German Association for Welding Technology “DVS 2225”.

For the hot-gas welding of plastic membranes of this type, devices are used, such as are known, for example, from WO 2004/085759 or U.S. Pat. No. 6,325,126. These devices have a hot-gas blower, by means of which heated air at a temperature of approximately 250° to 600° Celsius is blown through a wide slit nozzle between the thermoplastic films in order to soften the film regions to be connected. The film regions plasticized in this way are subsequently materially connected, that is to say welded, to one another with the aid of pressure cylinders or pressure rollers.

It has become apparent that, during lengthy storage of the plastic membranes in the open, the surfaces of these membranes change their nature under climatic influences, in particular under the influence of rain, cold, airborne dirt and/or solar radiation. This applies to all the materials from which plastic membranes are manufactured. This change in nature makes it difficult to weld the films satisfactorily and may necessitate complicated preparatory work, in particular cleaning operations, using solvent-containing products. It will be appreciated that local differences in the seam quality which result from this are undesirable.

It has therefore also already been proposed by EP 1 358 993 to provide the wide slit nozzle of the welding devices with a rubbing arrangement, also called a nozzle attachment below, which follows the hot-gas slit nozzle. This nozzle attachment consists essentially of a one-part or multipart, conically tapering cylinder arrangement and results in welded joints of high quality. There is the need, however, to increase the welding quality even further and consequently also to improve the mounting or laying of the sealing-off membranes.

### PRESENTATION OF THE INVENTION

The object of the present invention, therefore, is to provide a device for the welding of plastic membranes, which makes it possible to weld plastic membranes by means of hot-gas welding, without quality losses, in particular weak points, consequently having to be accepted during welding.

This is achieved, according to the invention, by means of the features of the first claim.

The essence of the invention, therefore, is that the nozzle attachment is held movably.

The advantages of the invention are to be seen, inter alia, in that the devices according to the invention for the welding of plastic membranes, with a movable holding of the nozzle attachment, ensure that the pressure force of the nozzle attachment is always sufficiently high. By the nozzle attachment being held movably, and because of the constant pressure force thus achieved, an improvement in the seam quality of the plastic sealing membranes to be welded is obtained.

The nozzle attachment thus always lies with a defined force on the lower membrane to be welded. This gives rise to a constant good seam quality, and, particularly in the case of T-joints, a good seam quality can thus be achieved.

In addition to the use of conventional rubbing members, it is particularly advantageous if the rubbing member elements are held on a bearing shaft and have a radial clearance of different size with respect to the bearing shaft. The cross section of the rubbing member formed from these rubbing member elements may per se be of any desired kind, in particular circular, elliptic or drop-shaped. It will be appreciated that this rubbing member may also be formed from rubbing member elements having an angular cross-sectional profile. The overall rubbing member may in this case be cylindrical or have a conically tapering shape. In practice, rubbing members have proved appropriate which have a smooth or structured surface, depending on the material of the plastic membranes. In this case, it has become apparent that, for the welding of PVC membranes, a smooth rubbing member leads to better welding results, while, for the welding of membranes based on polyolefin, the use of a welding member with a structured surface leads to better welding. In this case, a person skilled in the art, without further inventive effort, will select the structuring most suitable for the respective material, in particular use grooved or helically structured rubbing members. By exchangeable nozzle attachments being used for different materials, based, for example, on thermoplastics, elastomers, polyolefins or other polymers, the same welding device can be employed.

It is particularly expedient if the bore of the rubbing members is formed eccentrically.

Further advantageous refinements of the invention may be gathered from the dependent claims.

### BRIEF DESCRIPTION OF THE DRAWING

Exemplary embodiments of the invention are explained in more detail below with reference to the drawings. Identical elements are given the same reference symbols in the various figures.

Of the figures:

FIG. 1 shows a diagrammatic view of a hot-air nozzle provided with a nozzle attachment;

FIG. 2 shows a diagrammatic illustration of a nozzle attachment;

FIG. 3 shows a diagrammatic illustration of a nozzle attachment according to the invention with movable holding means;

FIGS. 4A, 4B show a diagrammatic illustration of movable holding means according to the invention;

FIG. 5 shows a diagrammatic illustration of a movable holding means according to the invention.

Only the elements essential for an immediate understanding of the invention are shown. What are not illustrated, for example, are the hot-gas generator and the welding machine, such as are known, for example, from EP 1 358 993.

### WAY OF IMPLEMENTING THE INVENTION

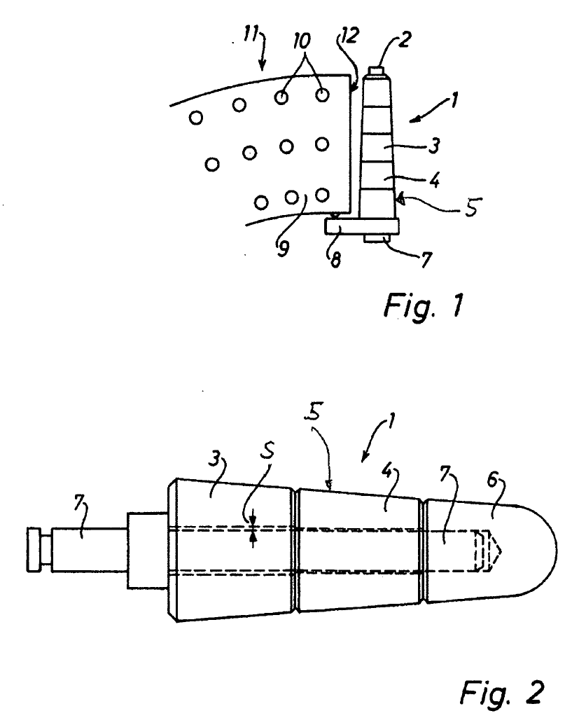

The device, illustrated in FIG. 1, for the welding of plastic membranes comprises a hot-air nozzle 11 and a nozzle attachment 1. The hot-air nozzle 11 has a slit-like outlet orifice 12 from which the hot air can emerge. Perforations or very small holes 10 are provided in the region of this outlet orifice 12 of the nozzle body 9. The hot air emerging from these perforations leads to a first softening of the film membranes arranged one above the other. This outlet orifice 12 is followed by the nozzle attachment 1 which comprises a rubbing arrangement, a rubbing member 5. The rubbing member 5 may be formed from a plurality of rubbing member elements, rubbing cylinders 3, 4, arranged next to one another. The rubbing member 5 is held by a lateral holding bracket 8. The individual rubbing cylinders 3, 4 are lined up on a shaft 7 and form a conically tapering cylinder arrangement. The rubbing cylinders are held on the shaft 7 by a holding means 2. During the welding of two plastic membranes, these are guided over the nozzle body 9 and the following nozzle attachment 1. In this case, the individual rubbing cylinders 3, 4 can rotate with respect to one another as a function of the frictional forces acting on them. These different frictional forces are generated by unevennesses in the region of the welding seam to be formed and by differences in the local nature of the surface.

FIG. 2 shows a diagrammatic illustration of a particularly advantageous rubbing member 5. This rubbing member 5 has three rubbing member elements 3, 4, 6 which are held on a common bearing shaft 7. The outermost rubbing member element 6 is advantageously firmly connected, in particular screwed in a self-locking manner, to this bearing shaft 7. The other rubbing member elements 3, 4 have a bore, the diameter of which is larger than the diameter of the bearing shaft 7. These rubbing member elements 3, 4 are consequently held on the bearing shaft 7 with a certain clearance S. The individual rubbing member elements 3, 4 are advantageously designed such that they have a radial clearance S of different size. In a preferred embodiment, the bearing shaft 7 has a diameter of 3.5 mm, while the rubbing member elements 3, 4 have in each case a bore diameter of 3.8 and 3.6 mm respectively. This design makes it possible to take into account optimally the locally different frictional forces and the unevennesses in the region of the welding seam to be formed. In particular, the movability of the individual rubbing member elements leads to an appreciable reduction in the formation of cinders which are detrimental to the welding quality. It will be appreciated that the rubbing member 5 may also be formed from four, five or more rubbing member elements. The rubbing member 5 advantageously has a conically tapering shape, but may also simply be cylindrical. The cross section of the individual rubbing member elements 3, 4, 6 may in this case be circular, elliptic or in the form of a wing profile or have an angular profile. It has proved to be particularly advantageous if the individual rubbing member elements 3, 4, 6 are manufactured from a metallic material, in particular from tungsten or a copper alloy. It will be appreciated that these rubbing member elements 3, 4, 6 may also be provided merely with a suitable non-stick coating. A person skilled in the art, in choosing a suitable material, will take into consideration the temperature resistance, thermal conductivity, wear resistance, corrosion resistance, etc.

The rubbing member elements 3, 4, 6 advantageously have an eccentric bore, the diameter of which, here too, is larger than the diameter of the bearing shaft 7. As a result, the individual rubbing member elements can adapt even more effectively to unevennesses occurring on the substrate, and welding is improved.

In a development of the rubbing member elements 3, 4, 6, these have a structured surface and, in particular, are grooved or helically structured. This special surface configuration makes it possible to adapt the rubbing member 5 optimally to the respective nature of the plastic membranes to be welded.

It will be appreciated that other rubbing members 5 than those described above may also be used for the invention present here. In particular, rubbing members, such as are described in EP 1 358 993, may also be used.

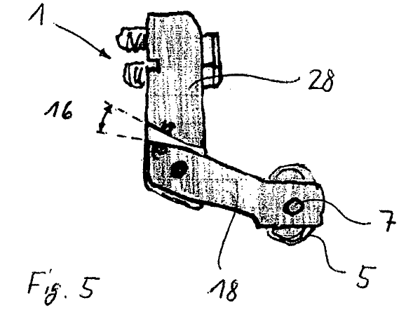

FIG. 3 illustrates in detail the device with a movable nozzle attachment 1. The rubbing member 5 is connected via the holding bracket 8 to the hot-air nozzle 11 which is not illustrated here. Here, according to the invention, the holding bracket 8 consists of two parts 18 and 28 which are connected movably to one another. These two parts 18, 28 of the holding bracket 8 are connected movably to one another here by means of a rotary joint 14, so that the rubbing member 5 is rotatable about the axis 15 with respect to the hot-air nozzle. According to FIG. 5, in this case, the deflection can be limited, so that only deflection through the angle 16 is possible. This limitation may, of course, also take place in a way other than that illustrated in FIG. 5. Via a force element 17, here a spring, the part 18 is pressed against the lower boundary of the joint. A suitable choice of the spring characteristic ensures that the nozzle attachment 1 lies with a defined force on the surface of the lower membrane to be welded. The force element may also be produced from other materials, for example as an elastic plastic body, etc.

During welding, then, the device is moved over the lower membrane or the membrane is moved over the device, and the movably held rubbing member 5 adapts automatically to the position of the lower membrane, so that unevennesses can be compensated in a simple way and a sufficient pressure force can be achieved in any position. The nozzle attachment thus always lies with a defined force on the lower membrane to be welded. This gives rise to a constant good seam quality, and, in particular, in the case of T-joints, a good seam quality can thus be achieved.

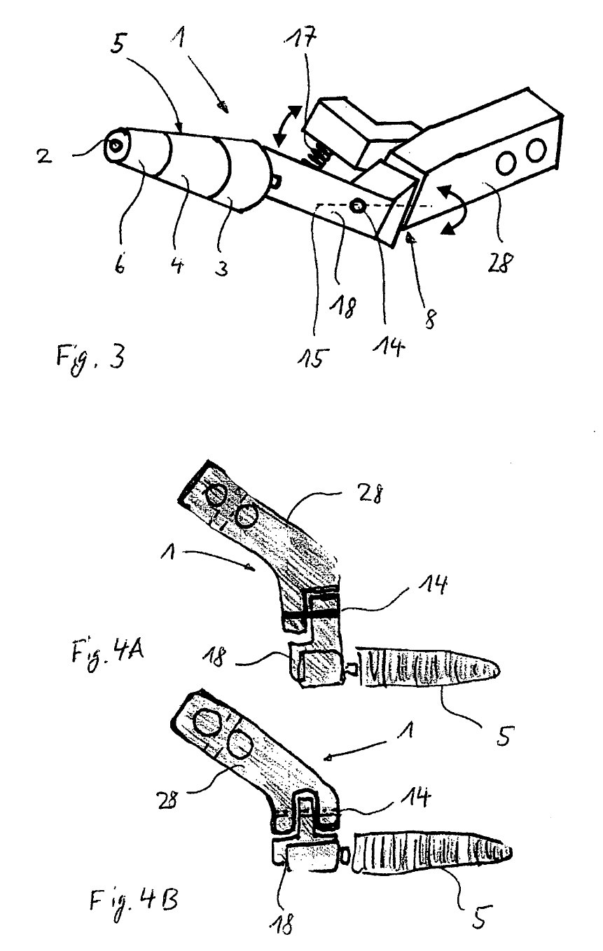

FIGS. 4A and 4B illustrate possible embodiments of the joint 14. The embodiment of the joint is in this case per se of any desired kind and must in each case be adapted to the forces which occur. Other joints, such as, for example, ball joints, etc., may also be used.

The nozzle attachment according to the invention can be fastened in a simple way to existing hot-gas welding appliances of any type, in particular also to welding appliances for producing a single or double seam. Furthermore, by means of this nozzle attachment, even decorative profiles or, to imitate elbow seam roofs, baton profiles made from plastic can be welded directly onto plastic membranes already laid.

The invention, of course, is not restricted to the exemplary embodiment shown and described.

1. A device for the welding of plastic membranes, comprising a nozzle attachments, the nozzle attachment having a rubbing member wherein the nozzle attachment is held movably.

2. The device as claimed in claim 1, wherein the nozzle attachment comprises a force element by means of which the rubbing member can be pressed onto the plastic membrane to be welded.

3. The device as claimed in claim 2, wherein the force element is an elastic element, in particular a spring.

4. The device as claimed in claim 1, wherein the nozzle attachment comprises a holding bracket, and the holding bracket consists of two parts which are connected to one another by means of a joint.

5. The device as claimed in claim 2, wherein the force element acts on the two parts of the holding bracket.

6. The device as claimed in claim 1, wherein the rubbing member consists of a plurality of rubbing member elements.

7. The device as claimed in claim 6, wherein the individual rubbing member elements can be offset radially with respect to one another.

8. The device as claimed in claim 6, wherein the individual rubbing member elements have a radial clearance of different size with respect to the bearing shaft.

9. The device as claimed in claim 6, wherein the individual rubbing member elements have an eccentric bore.

10. The device as claimed in claim 1, wherein a cross section of the rubbing member or of the rubbing member elements is circular, elliptic or drop-shaped.

11. The device as claimed in claim 1, wherein the rubbing member the rubbing member elements are manufactured from a metallic material.

12. The device as claimed in claim 1, wherein the rubbing member is cylindrical or has a conically tapering shape.

13. The device as claimed in claim 6, wherein the individual rubbing member elements have a smooth or structured surface.

14. The device as claimed in claim 13, wherein the individual rubbing member elements are grooved or helically structured.

15. The device as claimed in claim 1, wherein the rubbing member is held via a holding means in such a way that the rubbing member is exchangeable.
